(19) United States
(12) Patent Application Publication
(10) Pub. No.: US 2011/0187535 A1
(43) Pub. Date: Aug. 4, 2011

(54) METHODS, SYSTEMS, AND APPARATUS FOR DETECTING MEDICAL DEVICES

(76) Inventors: Christopher W. Crowley, San Diego, CA (US); Erik E. Magnuson, Cardiff, CA (US); Alejandro Bussandri, La Jolla, CA (US)

(21) Appl. No.: 12/820,457

(22) Filed: Jun. 22, 2010

Related U.S. Application Data
(60) Provisional application No. 61/301,465, filed on Feb. 4, 2010.
(60) Provisional application No. 61/322,081, filed on Apr. 8, 2010.

(51) Int. Cl. G08B 23/00

(52) U.S. Cl. 340/573.1

(57) ABSTRACT

A passenger screening device includes a transmission coil that is configured to apply radio frequency (RF) energy into a region of interest of a passenger at a frequency that is associated with a normal human body temperature, and a reception coil that is configured to detect an energy perturbation in response to the RF energy representative of a medical device on or within the passenger.

### CROSS REFERENCE TO RELATED APPLICATIONS

This application claims the benefit of U.S. Patent Application No. 61/301,465 filed Feb. 4, 2010 and U.S. Patent Application No. 61/322,081 filed on Apr. 8, 2010, which are both hereby incorporated by reference in their entireties.

### BACKGROUND

The embodiments described herein relate generally to screening passengers and, more particularly, to screening passengers that wear medical devices or that have implanted medical devices.

At least some known passenger screening systems detect contraband. As used herein, the term “contraband” refers to illegal substances, explosives, narcotics, weapons, a threat object, and/or any other material that a person is not allowed to possess in a restricted area, such as an airport. The contraband detection involves a combination of sensors and structures to control a flow of passengers. Although passengers are referred to herein, any person and/or object may be scanned using the system and apparatus described herein.

For example, one known checkpoint system first screens passengers with a whole-body walk-through metal detector (WTMD). In such a checkpoint system, when a threat item or anomaly is detected from a whole body scan, the passenger is directed to a wanding station, which is a physical structure that controls the progress of the passenger. Importantly, if a threat item or anomaly is detected by the whole body scan, then the passenger may be considered a threat. As such, his or her mobility is controlled by the structure of the wanding station. Within that controlled structure, or at its egress, a security officer can use a metal detection wand to perform a localized scan of the passenger's body to resolve the alarm. If the passenger is then cleared, he or she may proceed beyond the physical structures of the wanding area. However, there are limits to such systems.

For example, at least one known metal detection wand is a quadrupole resonance (QR) wand that includes a QR sensor for producing QR signals. The QR wand can detect metal and/or predefined chemical compounds, such as explosive, narcotics, and/or other contraband compounds, using the QR sensor. Radio frequency interference (RFI) of the QR signals produced by the QR wand is managed by an auxiliary system that remotely measures RFI and then performs a subtraction to obtain a correct signal. However, this electronic approach has limitations involving dynamic range, for example, as well as motion of an RFI reference relative to the QR sensor. Also, such an approach is theoretically limited in the case of multiple sources of RFI, which might occur in an airport setting. The QR wand may also be limited with respect to sweeping scans in which whole portions of a passenger's body or the ground are to be scanned by sweeping the QR wand. Moreover, known QR wands are generally operated at or near an ambient temperature of the venue, which limits the accuracy of data obtained with such QR wands. For example, known QR wands are generally operated at a nominal operating frequency that is associated with the room temperature of the venue, which may limit the accuracy of data obtained with such QR wands. Accordingly, it is desirable to provide a QR sensor system that overcomes the difficulties associated with the known QR wand.

Implanted medical devices are designed to be as small and light as possible, while maintaining the longest possible battery life. Accordingly, such medical devices use very low power electronics, which implies low voltage operation and limited frequency response for the active components (e.g. op amps). The combination of low voltage operation and limited frequency response can lead to increased susceptibility to high frequency overload of the active components which then interferes with the proper functioning of the overall device.

One workaround is to place low-pass filters on the external connections of medical devices to block interference from cell phones operating at a frequency greater than approximately 0.5 GHz. However, these filters become larger as the blocking frequency is reduced. Because QR frequencies are typically one thousand times lower than frequencies used by cell phones, the filters would become too large for use with medical devices. In general, passengers wearing or carrying a medical device are informed of the risks associated with medical devices being exposed to normal imaging or scanning systems. Passengers may also carry a card that indicates that such passengers should not be subjected to security scans that could result in an adverse interaction. However, it is possible that language barriers, forgetfulness, or a misunderstanding could lead to undesirable exposure to the passenger.

### BRIEF DESCRIPTION

In one aspect, a method is provided for screening a passenger at an inspection checkpoint. The method includes performing a preliminary screen of the passenger using a screening device, and detecting whether a medical device is present on or within the passenger based on a result of the preliminary screen. When the medical device is not present, a primary scan of the passenger is performed, and when the medical device is present, a secondary screen of the passenger is performed at a secondary screening station.

In another aspect, an inspection checkpoint includes a preliminary screening station having a screening device configured to detect a presence of a medical device on or within a passenger, a primary scanning system configured to perform a primary scan of the passenger when the medical device is not detected, and a secondary screening station configured to perform a secondary screening of the passenger when the medical device is detected.

In another aspect, a screening device includes a transmission coil that is configured to apply radio frequency (RF) energy into a region of interest of a passenger at a frequency that is associated with a normal human body temperature, and a reception coil that is configured to detect an energy perturbation in response to the RF energy representative of a medical device on or within the passenger.

### BRIEF DESCRIPTION OF THE DRAWINGS

The embodiments described herein may be better understood by referring to the following description in conjunction with the accompanying drawings.

FIG. 1 is a schematic top view of an exemplary inspection checkpoint.

FIG. 2 shows an exemplary screening device that may be used with the inspection checkpoint shown in FIG. 1.

FIG. 3 is a schematic view of an exemplary electrical architecture of the screening device shown in FIG. 2.

FIG. 4 is a schematic view of an exemplary interaction between the screening device shown in FIG. 2 and a passenger.

FIG. 5 is a flowchart that illustrates an exemplary method of screening a passenger.

### DETAILED DESCRIPTION

Exemplary embodiments of methods, systems, and apparatus for use in screening passengers are described herein. The embodiments described herein facilitate identifying the presence of medical devices implanted within passengers, including implantable cardiac defibrillators, pacemakers, insulin pumps, electro-stimulation devices, and/or electrotherapy devices. Identifying such devices prior to screening a passenger using an imaging device facilitates reducing opportunities for the imaging device to adversely interact with such medical devices an possibly causing malfunctions, for example.

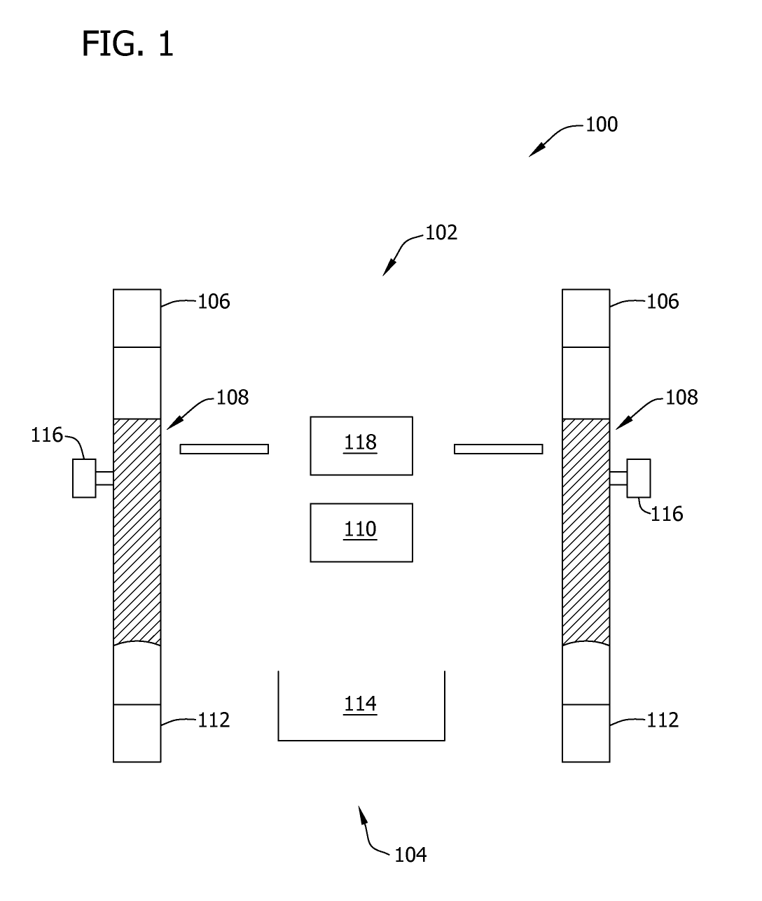

FIG. 1 is a schematic top view of an exemplary inspection checkpoint 100. Inspection checkpoint 100 includes an entrance 102 and an exit 104. In series between entrance 102 and exit 104, inspection checkpoint 100 includes a divesting area 106, a baggage imaging system 108, a passenger imaging system 110, a composing area 112, and a secondary screening station 114. In the exemplary embodiment, inspection checkpoint 100 includes two divesting areas 106, two baggage imaging systems 108, and two composing areas 112. However, inspection checkpoint 100 may include any suitable number and/or configuration of components that enables inspection checkpoint 100 to function as described herein. Components of inspection checkpoint 100 are communicatively coupled to a control system 116 for collecting and/or relaying data.

Passenger imaging system 110 is configured to detect whether contraband and/or an anomalous item is associated with a passenger. In the exemplary embodiment, passenger imaging system 110 may be a millimeter wave system, an X-ray backscatter system, and/or any other suitable security system. Further, in the exemplary embodiment, passenger imaging system 110 includes a portal (not shown) in which the passenger is positioned during imaging.

In the exemplary embodiment, inspection checkpoint 100 also includes a preliminary screening station 118 that facilitates screening passengers for medical devices, such as pacemakers and the like. In the exemplary embodiment, passengers are screened at preliminary screening station 118 using a handheld wand (not shown in FIG. 1) as described herein. In an alternative embodiment, preliminary screening station 118 includes a portal (not shown) that screens passengers for medical devices as the passengers move through passenger scanning portal 118 and prior to the passengers entering passenger imaging system 110. For example, preliminary screening station 118 may be embodied as a scanning portal including an abdomen scanner having one or more inductive sensors that are positioned with respect to the passenger to detect medical devices on or within a passenger's body. In such an embodiment, the inductive sensors are movable to varying heights to accommodate differently sized passengers. Moreover, the inductive sensors may include nuclear quadrupole resonance (NQR) sensors, nuclear magnetic resonance (NMR) sensors, inductive metal detection sensors, and the like. Accordingly, in one embodiment, the abdomen scanner includes shielding that enhances a signal-to-noise ratio by reducing radio frequency interference and/or electromagnetic interference from the operating environment. Such shielding may include conductive plates coupled to a floor and/or a ceiling of preliminary screening station 118.

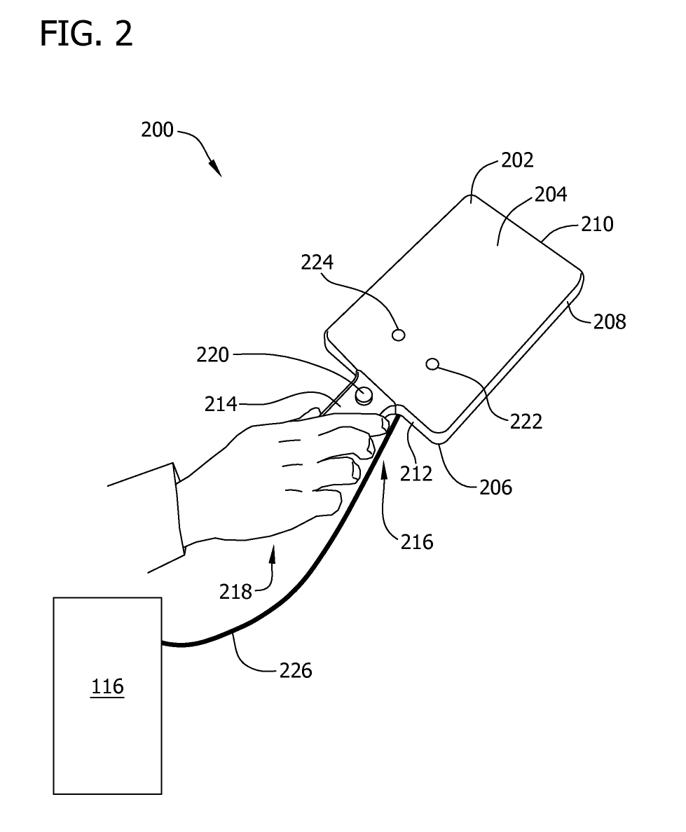

FIG. 2 illustrates an exemplary screening device 200 for use in preliminary screening station 118 (shown in FIG. 1). In the exemplary embodiment, screening device 200 includes a detector 202 having a top surface 204, an opposite bottom surface 206, and an edge 208 that extends about detector 202 between top surface 204 and bottom surface 206. Moreover, detector 202 includes a first end 210 and an opposite second end 212. Top surface 204, bottom surface 206, and edge 208 define a paddle-shaped, handheld wand. Accordingly, screening device 200 also includes a handle 214 that is coupled to or integrated with second end 212. In one embodiment, handle 214 includes a first end 216 coupled to detector second end 212 and an opposing second end 218.

Moreover, handle 214 includes an input device 220 for receiving operator inputs. For example, an operator may adjust a frequency of pulses transmitted by detector 202 and/or an intensity of the pulses transmitted by detector 202. Alternatively, input device 220 may be used to activate and/or deactivate screening device 200. For example, an operator may deactivate screening device 200, via input device 220, during periods of inactivity. Further, detector 202 includes one or more indicators, which may be visual indicators, such as lights, or aural indicators, such as speakers. For example, a first indicator 222 may be selectively illuminated when a medical device is detected on or within a passenger. Similarly, a second indicator 224 may be selectively illuminated when no medical device is detected on or within the passenger.

In the exemplary embodiment, screening device 200 is coupled to a computer, such as control system 116. Accordingly, control system 116 transmits operational commands and/or receives screening data from screening device 200. Control system 116 and screening device 200 communicate via a cable 226. Cable 226 may also be used to provide power to screening device 200. In an alternative embodiment, screening device 200 is cordless and is powered by one or more batteries (not shown).

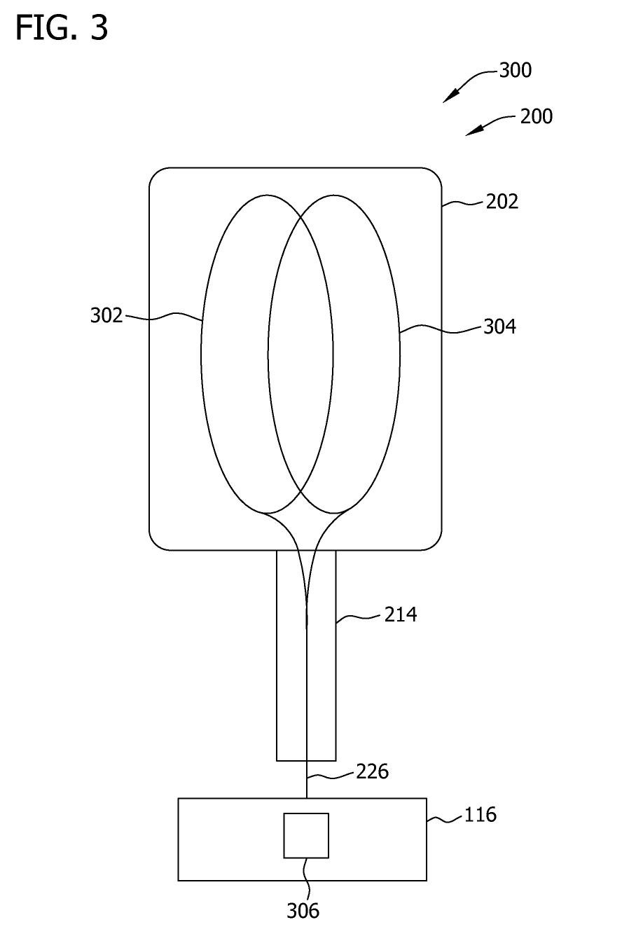

FIG. 3 is a schematic diagram of an exemplary electrical architecture 300 of screening device 200. In the exemplary embodiment, detector 202 includes a transmission coil 302 and a reception coil 304. Transmission coil 302 transmits pulses towards a region of interest within a passenger. In the exemplary embodiment, transmission coil 302 transmits pulses at a selected frequency that is substantially higher than an operation frequency of known medical devices. For example, at least some known medical devices operate in a frequency band that is less than approximately 1 kilohertz (kHz) or 2 kHz according to the Association for the Advancement of Medical Instrumentation (AAMI). Moreover, the AAMI supports operations by scanning and/or screening devices in a frequency band that is approximately one thousand times that of operating frequencies of known medical devices. Nerves and/or muscle tissue in the heart, for example, are less sensitive to electro-stimulation at such increased frequencies, as articulated in the IEEE C95.1 standard. Further, transmission coil 302 transmits pulses with a low intensity of energy, as supported by the above AAMI and IEEE standards.

In the exemplary embodiment, detector 202 and, more particularly, transmission coil 302 and reception coil 304, is operated at or near a normal human body temperature, i.e., approximately 37.0° C. In some embodiments, however, detector 202 is operated within a range of the normal human body temperature, such as plus or minus approximately six degrees Celsius. Accordingly, in the exemplary embodiment, detector 202 is operated at an operating frequency that is associated with the normal human body temperature. In some embodiments, however, detector 202 is operated within a range of operating frequencies that is associated with a range of temperatures that includes the normal human body temperature. For example, in some embodiments, the operating frequency of detector 202 is shifted by approximately 100 Hz per degree Celsius. Moreover, in some embodiments, the operating frequency of detector 202 is shifted inversely with respect to temperature. For example, the operating frequency of detector 202 decreases as the temperature increases. In one embodiment, the operating frequency of detector 202 is controlled by an operator at control system 116. Moreover, in some embodiments, detector 202 is capable of operating at multiple frequencies. For example, detector 202 may be operated initially in a safe mode, using a lower power, to detect a medical device, and may then be operated in a detection mode, using a higher power, to detect contraband.

In the exemplary embodiment, reception coil 304 detects any perturbation in energy in response to the pulses transmitted by transmission coil 302. For example, reception coil 304 detects an opposite magnetic field, such as a reflected pulse, that is emitted by a medical device within the region of interest in response to the pulse transmitted by transmission coil 302. Reception coil 304 generates a signal representative of, for example, an intensity of the reflected pulse and/or a time period during which the reflected pulse was detected, and transmits the signal to control system 116.

In the exemplary embodiment, control system 116 is coupled to screening device 200 via cable 226. Control system 116 receives the signal from reception coil 304 via cable 226 and analyzes the signal to determine whether a medical device is present on or within the passenger. Control system 116 includes a sampling circuit 306, such as a processor or a controller, which analyzes the signal. Sampling circuit 306 monitors a length of the time period that the reflected pulse is detected, and compares the length to an expected length of time of a reflected pulse that may be received from a passenger that does not have an implanted medical device. In one embodiment, sampling circuit 306 uses a preselected averaging time that is related to the higher frequency and/or the lower power used by transmission coil 302. Based on the analysis of the signal, control system 116 causes detector 202 to output a result using, for example, first indicator 222 and/or second indicator 224.

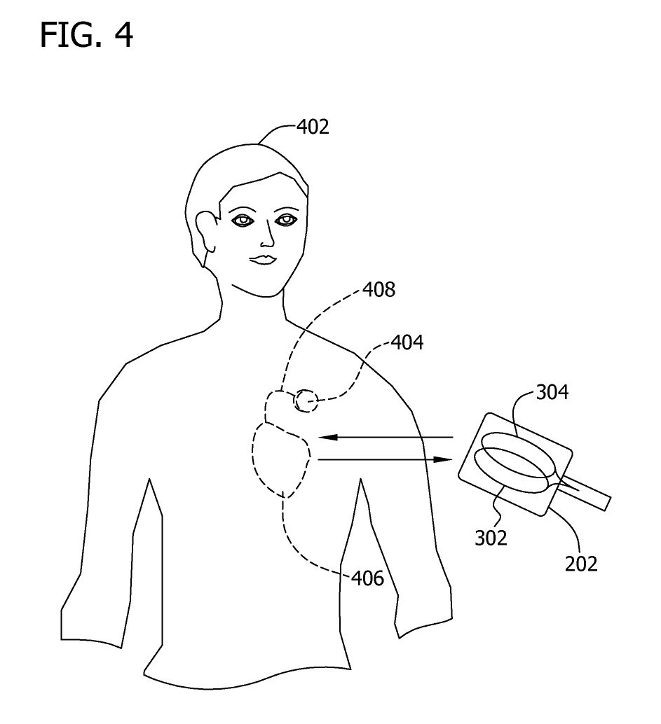

FIG. 4 is a schematic diagram of an interaction between screening device 200 and a passenger 402. As shown in FIG. 4, passenger 402 has an implanted medical device. Specifically, passenger 402 has a pacemaker 404 that is connected to his heart 406 via an electrical lead 408. During operation, control system 116 (shown in FIGS. 1-3) selectively activates transmission coil 302. In response, transmission coil 302 transmits pulses into a region of interest of passenger 402 using a selected frequency and a selected intensity. Each pulse causes pacemaker 404 and/or lead 408 to emit a reflected pulse. Reception coil 304 detects the reflected pulse, and transmits a signal representative of the reflected pulse to control system 116 via cable 226 (shown in FIGS. 2 and 3). Control system 116 determines the presence of pacemaker 404 and/or lead 408 based on a time-averaged comparison of the signal from reception coil 304. For passengers 402 without a medical device, such as pacemaker 404, reception coil 304 does not detect a reflected pulse that extends beyond a specified time period thus indicating that there is no medical device, such as an implanted medical device, on or within passenger 402.

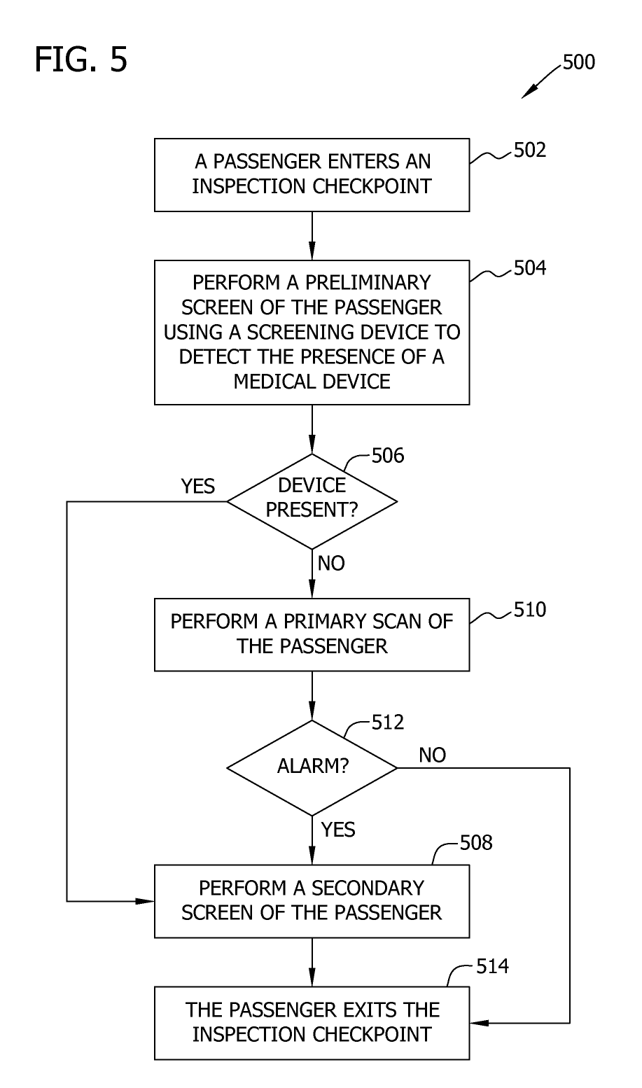

FIG. 5 is a flowchart 500 that illustrates an exemplary method of screening a passenger, such as passenger 402 (shown in FIG. 4), for an implantable medical device, such as a pacemaker 404 (shown in FIG. 4) and/or an electrical lead 408 (shown in FIG. 4) for use with pacemaker 404. More specifically, the method shown in FIG. 5 may be used with inspection checkpoint 100 having preliminary screening station 118 (both shown in FIG. 1). Moreover, the method shown in FIG. 5 is performed by control system 116 (shown in FIGS. 1-3) by sending commands and/or instructions to components of inspection checkpoint 100. In some embodiments, a processor within control system 116 is programmed with code segments configured to perform the method shown in FIG. 5. Alternatively, the method shown in FIG. 5 is encoded on a computer-readable medium that is readable by control system 116. In such an embodiment, control system 116 and/or the processor is configured to read computer-readable medium for performing the method shown in FIG. 5. In the exemplary embodiment, the method shown in FIG. 5 is automatically performed continuously and/or at selected times. Alternatively, the method shown in FIG. 5 is performed upon request of an operator of inspection checkpoint 100 and/or when control system 116 determines to perform the method shown in FIG. 5.

In the exemplary embodiment, passenger 402 enters 502 inspection checkpoint 100 via entrance 102 (shown in FIG. 1). In divesting area 106 (shown in FIG. 1), passenger 402 removes items, such as metal items, and places any baggage within baggage inspection system 108 (shown in FIG. 1). Passenger 402 then enters preliminary screening system 118. A preliminary screen is performed 504 of passenger 402 using screening device 200 (shown in FIGS. 2 and 3) to detect 506 the presence of a medical device, such as pacemaker 404 and/or lead wire 408 (both shown in FIG. 4). For example, control system 116 selectively activates transmission coil 302 (shown in FIGS. 3 and 4). In response, transmission coil 302 transmits pulses into a region of interest of passenger 402 using a selected frequency and a selected intensity. In the exemplary embodiment, transmission coil 302 operates at an operating frequency that is associated with the normal human body temperature. Each pulse causes pacemaker 404 and/or lead 408, if present on or within passenger 402, to emit a reflected pulse. Reception coil 304 (shown in FIGS. 3 and 4) detects the reflected pulse, and transmits a signal representative of the reflected pulse to control system 116 via cable 226 (shown in FIGS. 2 and 3) or via wireless communication. Control system 116 determines the presence of pacemaker 404 and lead 408 based on a time-averaged comparison of the signal from reception coil 304. If a medical device is detected 506, a secondary screen is performed 508 of passenger 402 using a screening means that is different than passenger imaging system 110. One example of a secondary screening means is a manual search or pat down of the passenger by an operator, such as a Transportation Security Agency (TSA) agent or a security officer (not shown). However, it should be understood that any suitable screening means for detecting contraband may be used at secondary screening station 114 such that the screening means does not pose a substantial threat of causing interference or harm to an implanted or worn medical device.

If no medical device is detected 506, a primary scan of passenger 402 is performed 510 using passenger imaging system 110. More specifically, passenger imaging system 110 uses a modality to collect data related to passenger 402 and objects associated with passenger 402. Using the data collected by passenger imaging system 110, an operator, such as a TSA agent or a security officer, and/or control system 116 determine 512 if an alarm object is associated with passenger 402. As used herein, the term “alarm object” refers to an object that is suspicious and/or unclear from the collected data related to passenger 402. The suspicious object may include contraband. As described above, the term “contraband” refers generally to illegal substances, explosives, narcotics, weapons, a threat object, and/or any other material that a passenger is not allowed to possess in a restricted area, such as an airport. Alternatively, the primary scan may of passenger 402 may be performed 510 using detector 202 is capable of operating at multiple frequencies. For example, screening device 200 may be operated initially in a safe mode, using a lower power, to detect whether a medical device within or worn by passenger 402, and may then be operated in a detection mode, using a higher power, to determine 512 if an alarm object is associated with passenger 402.

When it is determined 512 that the alarm object is not associated with passenger 402, passenger 402 proceeds through inspection checkpoint 100 to composing area 112 (shown in FIG. 1) to retrieve baggage and other divested items. Passenger 402 then exits 514 inspection checkpoint 100 via exit 104 (shown in FIG. 1). When is it determined 512 that the alarm object is associated with passenger 402, passenger 402 is directed 508 into secondary screening area 114 for further investigation.

Exemplary embodiments of methods, systems, and apparatus for screening a passenger are described above in detail. The methods, systems, and apparatus are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A computer or control system, such as those described herein, includes at least one processor or processing unit and a system memory. The computer typically includes at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present invention is described in connection with an exemplary passenger screening system environment, embodiments of the invention are operational with numerous other general purpose or special purpose passenger screening system environments or configurations. The passenger screening system environment is not intended to suggest any limitation as to the scope of use or functionality of any aspect of the invention. Moreover, the passenger screening system environment should not be interpreted as having any dependency or requirement relating to any one or combination of components illustrated in the exemplary operating environment. Examples of well known passenger screening systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “processor” refers generally to any programmable system including systems and microcontrollers, reduced instruction set circuits (RISC), application specific integrated circuits (ASIC), programmable logic circuits, and any other circuit or processor capable of executing the functions described herein. The above examples are exemplary only, and thus are not intended to limit in any way the definition and/or meaning of the term processor.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for screening a passenger at an inspection checkpoint, said method comprising:
performing a preliminary screen of the passenger using a screening device;
detecting whether a medical device is present on or within the passenger based on a result of the preliminary screen;
when the medical device is not present, performing a security scan of the passenger; and
when the medical device is present, performing a secondary screen of the passenger.

2. A method in accordance with claim 1, wherein performing a preliminary screen comprises:
transmitting at least one pulse to a region of interest of the passenger; and
detecting a reflected pulse emitted by the medical device in response to the at least one pulse.

3. A method in accordance with claim 2, wherein transmitting at least one pulse to a region of interest of the passenger comprises transmitting a plurality of pulses at a frequency that is associated with a normal human body temperature.

4. A method in accordance with claim 2, wherein determining if a medical device is present comprises using a time-averaged comparison between the detected reflected pulse and a predefined reflected pulse associated with an absence of the medical device.

5. A method in accordance with claim 1, wherein performing a security scan of the passenger comprises scanning the passenger using an imaging system.

6. A method in accordance with claim 1, wherein performing a security scan of the passenger comprises scanning the passenger using a quadrupole resonance (QR) device.

7. An inspection checkpoint comprising:
a preliminary screening station comprising a screening device configured to detect a presence of a medical device on or within a passenger;
a primary scanning system configured to perform a security scan of the passenger when the medical device is not detected; and
a secondary screening station configured to perform a secondary screen of the passenger when the medical device is detected.

8. An inspection checkpoint in accordance with claim 7, wherein said preliminary screening station comprises an inductive sensor comprising:
a transmission coil configured to transmit at least one pulse to a region of interest of the passenger; and
a reception coil configured to detect a reflected pulse emitted by the medical device in response to the at least one pulse.

9. An inspection system in accordance with claim 8, wherein said transmission coil is configured to transmit a plurality of pulses to the region of interest at a specified frequency that is higher than an operating frequency of the medical device.

10. An inspection system in accordance with claim 8, wherein said transmission coil is configured to transmit a plurality of pulses to the region of interest at a frequency that is associated with a normal human body temperature.

11. An inspection system in accordance with claim 8, further comprising a control system coupled to said preliminary screening station, wherein said reception coil is configured to generate a signal representative of the reflected pulse and transmit the signal to said control system for detecting whether the medical device is present.

12. An inspection system in accordance with claim 11, wherein said control system is configured to determine whether the medical device is present using a time-averaged comparison between the detected reflected pulse and a predefined reflected pulse associated with an absence of the medical device.

13. An inspection system in accordance with claim 7, wherein said screening device comprises at least one indicator configured to be selectively activated based on a determination that the medical device is present.

14. An inspection system in accordance with claim 7, wherein said primary scanning system comprises an imaging system.

15. An inspection system in accordance with claim 7, wherein said primary scanning system comprises a quadrupole resonance (QR) system.

16. An inspection system in accordance with claim 15, wherein said QR system is integrally formed with said screening device used at said preliminary screening station to detect a presence of the medical device on or within the passenger.

17. A screening device comprising:
a transmission coil configured to apply radio frequency (RF) energy into a region of interest of a passenger at a frequency that is associated with a normal human body temperature; and
a reception coil configured to detect an energy perturbation in response to the RF energy representative of a medical device on or within the passenger.

18. A screening device in accordance with claim 17, wherein said transmission coil is configured to apply the RF energy at a frequency that is greater than 1 Megahertz.

19. A screening device in accordance with claim 17, wherein said screening device comprises an inductive sensor comprising:
a transmission coil configured to transmit at least one pulse to a region of interest of the passenger; and
a reception coil configured to detect a reflected pulse emitted by the medical device in response to the at least one pulse.

20. A screening device in accordance with claim 19, wherein said reception coil is configured to generate a signal representative of the reflected pulse and transmit the signal to a control system for determining whether the medical device is present on or within the passenger.
